(19) United States
(12) Patent Application Publication
(10) Pub. No.: US 2026/0044512 A1
(43) Pub. Date: Feb. 12, 2026

(54) ARTIFICIAL INTELLIGENCE DEVICE FOR VERIFIABLE, DEBUGGABLE, AND REPAIRABLE COMMONSENSE LOGIC REASONING VIA LLM-BASED THEORY RESOLUTION AND METHOD THEREOF

(71) Applicants: LG ELECTRONICS INC., Seoul (KR); The Governing Council of the University of Toronto, Toronto (CA)

(72) Inventors: Armin TOROGHI, Toronto (CA); Ali PESARANGHADER, Toronto (CA); Willis GUO, Maple (CA); Scott SANNER, Scarborough (CA)

(73) Assignees: LG ELECTRONICS INC., Seoul (KR); The Governing Council of the University of Toronto, Toronto, ON (CA)

(21) Appl. No.: 19/294,008

(22) Filed: Aug. 7, 2025

Related U.S. Application Data
(60) Provisional application No. 63/680,584, filed on Aug. 7, 2024.

(51) Int. Cl. G06F 16/2455

(52) U.S. Cl. CPC G06F 16/24564

(57) ABSTRACT

A method for controlling an artificial intelligence (AI) device can include receiving a query including natural language, parsing, by a large language model-based parser, the query into a formal logical structure, initiating, by a theory resolution engine, a proof process to generate a logical proof for the query, and selecting, by a rules selector, a plurality of selected rules from a knowledge base that are relevant to an active logical clause in the proof process. Also, the method can further include generating, by the theory resolution engine, one or more logical clauses for the logical proof by applying one or more of the plurality of selected rules until a condition is met, and in response to meeting the condition, outputting an answer to the query and the logical proof corresponding to the answer.

### CROSS-REFERENCE TO RELATED APPLICATIONS

This non-provisional application claims priority under 35 U.S.C. § 119 (e) to U.S. Provisional Application No. 63/680,584, filed on Aug. 7, 2024, the entirety of which is hereby expressly incorporated by reference into the present application.

### BACKGROUND

### Field

The present disclosure relates to a device and method for enhancing the logical reasoning capabilities of large language models (LLMs), in the field of artificial intelligence (AI). Particularly, the method can implement a logical reasoning framework that can combine commonsense knowledge from a large language model with theory resolution to produce verifiable, debuggable, and repairable reasoning.

### Discussion of the Related Art

Artificial intelligence (AI) continues to transform various aspects of society and help users by powering advancements in various fields, particularly with regards to interactive applications, such as large language models (LLMs), virtual assistants, chat-bots, and knowledge base question answering (KBQA) systems.

For instance, Artificial intelligence (AI), particularly in the form of large language models (LLMs), is being increasingly utilized for tasks that involve commonsense reasoning. In addition to text generation, these models are being employed in various applications where they are expected to infer logical conclusions from a given context and trying to simulate a human like understanding of the world.

Despite their potential, existing LLM systems suffer from significant deficiencies that limit their reliability in critical applications. One issue is the problem of hallucinations, in which the LLM generates factually incorrect or logically flawed information with a high degree of confidence (with may even sound plausible). Further, the reasoning process of LLMs is often opaque, e.g., functioning as a type of “black box.” This lack of transparency makes it difficult or impossible for a user or developer to audit or verify the logical steps the model took to arrive at a conclusion.

This lack of verifiability leads to a further challenge, such as the inability to reliably debug or repair the model's reasoning. When an LLM produces an erroneous output, the opaque nature of its process makes it difficult to identify the specific cause of the error. Also, even if a flawed piece of logic is identified, no mechanism exists in the existing systems to implement a correction that is guaranteed to be used in the future to prevent similar errors.

In addition, some attempts have been made to try and mitigate these issues by integrating LLMs with formal logical systems. For example, these approaches may use an LLM as either a reasoner over a pre-existing, static knowledge base (KB), or attempt to use formal logic that can be processed by a separate theorem prover.

However, these methods are fundamentally limited. They are unable to extract new, emergent commonsense axioms from the LLM that are not already formalized in the knowledge base, and they lack a robust method to repair incorrect or missed inferences made by the LLM during the reasoning process.

Thus, a need exists for an improved device and method that can overcome the limitations of prior approaches by providing a logical reasoning framework that is fully verifiable, debuggable, and repairable, while still effectively leveraging the commonsense knowledge in large language models.

Furthermore, a need exists for a framework that can evaluate the quality and correctness of the underlying reasoning process itself. Conventional metrics for LLM agents typically focus only on the accuracy of the final output. However, these metrics fail to capture the logical soundness of the intermediate steps taken to reach a conclusion, making it difficult to distinguish between a correct answer derived from flawed logic and one derived from a valid line of reasoning.

Also, a need exists for a comprehensive framework that can systematically generate a formal proof for a given query by leveraging an LLM's commonsense knowledge, and validate the soundness of that proof through a verifiable, step by step resolution process that can guarantee the precedence or priority of corrected information.

### SUMMARY OF THE DISCLOSURE

The present disclosure has been made in view of the above problems and it is an object of the present disclosure to provide a device and method that can provide improved logical reasoning for large language models (LLMs) that is verifiable, debuggable, and repairable. Further, the method can provide enhanced logical reasoning by implementing a framework that combines commonsense knowledge from an LLM with theory resolution to generate a verifiable proof for a given query and to guarantee the precedence or priority of corrected information.

An object of the present disclosure is to provide an artificial intelligence (AI) device and method for a logical reasoning framework that can enhance a large language model's (LLM) ability to answer queries in a verifiable, debuggable and repairable manner. The method can utilize a multi-component framework to systematically generate and validate a formal proof for a given query. For example, an LLM-based parser component can translate a natural language query into a formal logical structure. Then, a theory resolution engine can be guided by a relevant rules selector that retrieves pertinent rules from a knowledge base to systematically build a proof tree. Further, a repair module can correct errors in the reasoning by adding a high priority rule to the knowledge base, thereby guaranteeing that the corrected logic is used in subsequent proofs. This can produce a logically sound and verifiable answer for the user while also providing a transparent, step-by-step proof that can be audited and corrected, thereby enhancing reliability and trustworthiness.

Another object of the present disclosure is to provide a method for controlling an artificial intelligence (AI) device that can include receiving, by a processor, a query in natural language, parsing, by an LLM-based parser, the natural language query into a formal logical structure, initiating, by a theory resolution engine, a proof process to generate a proof tree for the query, selecting, by a relevant rules selector, a plurality of rules from a knowledge base that are semantically relevant to a current step in the proof process, generating, by the theory resolution engine, one or more new steps in the proof tree by applying the selected rules, generating, by a repair module, a repair axiom configured to correct an error in the reasoning; storing the repair axiom in the knowledge base as a high-priority rule, prioritizing, by the theory resolution engine, the high-priority rule over other rules; and outputting a verifiable answer and the corresponding proof tree.

An object of the present disclosure is to provide a method for controlling an artificial intelligence (AI) device that can include receiving, by a processor in the AI device, a query including natural language, parsing, by a large language model-based parser, the query into a formal logical structure, initiating, by a theory resolution engine, a proof process to generate a logical proof for the query, selecting, by a rules selector, a plurality of selected rules from a knowledge base that are relevant to an active logical clause in the proof process, generating, by the theory resolution engine, one or more logical clauses for the logical proof by applying one or more of the plurality of selected rules until a condition is met, and in response to meeting the condition, outputting an answer to the query and the logical proof corresponding to the answer.

It is another object of the present disclosure to provide a method, in which the generating the one or more logical clauses or steps for the logical proof by applying the one or more of the plurality of selected rules until the condition is met includes generating, by the theory resolution engine, the one or more logical clauses for the logical proof by iteratively applying the plurality of selected rules until a logical contradiction is derived, and in response to deriving the logical contradiction, outputting the answer and the logical proof.

Yet another object of the present disclosure is to provide a method that includes receiving, by a repair module, a repair axiom configured to correct an error in reasoning, storing the repair axiom in the knowledge base as a high priority rule, prioritizing, by the theory resolution engine during the proof process, the high priority rule over one or more other rules derived from a large language model, and generating the answer based on the repair axiom.

An object of the present disclosure is to provide a method, in which the selecting the plurality of selected rules is based on a semantic relevance between the active logical clause and one or more rules in the knowledge base, and the semantic relevance is determined based on a vector embedding of the active logical clause and one or more vector embeddings corresponding to the one or more rules.

Another object of the present disclosure is to provide a method that further includes parsing the query into a negated query and designating the negated query as the active logical clause during the proof process for performing a backward chaining proof process.

An object of the present disclosure is to provide a method in which the generating the one or more logical clauses is managed by a priority queue, and the method further includes calculating, for each of the one or more logical clauses, a priority score, and adding each of the one or more logical clauses to the priority queue based on the priority score.

Yet another object of the present disclosure is to provide a method, in which the priority score is a tuple including at least a first value representing a proof entailment score and a second value representing a proof length score.

An object of the present disclosure is to provide a method, in which the formal logical structure is a Natural Language (NL)-Logic structure representing one or more predicates by natural language strings.

Another object of the present disclosure is to provide a method, in which the NL-Logic structure utilizes a function-free and equality-free first-order logical syntax.

An object of the present disclosure is to provide a method, in which the knowledge base includes a first set of type one rules having a first probability corresponding to ground truth rules known to be correct, and a second set of type two rules having a second probability of being correct that is lower than the first probability, the second set of rules being derived from a large language model.

An object of the present disclosure is to provide a method, in which the logical proof is a proof tree including a plurality of base premises, one or more rules of inference, one or more intermediate subgoals derived from applying the one or more rules of inference to the plurality of base premises, and a final goal corresponding to the query.

Another object of the present disclosure is to provide a method, in which the generating the one or more logical clauses includes calling, by the theory resolution engine, a large language model as a subroutine to determine a probability of an entailment for at least one axiom or rule extracted during the proof process, and generating a logical clause based on the probability of the entailment.

An object of the present disclosure is to provide a method, in which the logical proof is assigned a priority score based on an accumulated probability of a plurality of rules used to generate the logical proof.

Another object of the present disclosure is to provide an artificial intelligence (AI) device including a memory configured to store information for a large language model, and a controller configured to receive a query including natural language, parse, by a large language model-based parser, the query into a formal logical structure, initiate, by a theory resolution engine, a proof process to generate a logical proof for the query, select, by a rules selector, a plurality of selected rules from a knowledge base that are relevant to an active logical clause in the proof process, generate, by the theory resolution engine, one or more logical clauses for the logical proof by applying one or more of the plurality of selected rules until a condition is met, and in response to meeting the condition, outputting an answer to the query and the logical proof corresponding to the answer.

An object of the present disclosure is to provide a non-transitory computer readable medium storing computer-executable instructions that when executed by a processor, cause the processor to perform the operations of receiving a query including natural language, parsing, by a large language model-based parser, the query into a formal logical structure, initiating, by a theory resolution engine, a proof process to generate a logical proof for the query, selecting, by a rules selector, a plurality of selected rules from a knowledge base that are relevant to an active logical clause in the proof process, generating, by the theory resolution engine, one or more logical clauses for the logical proof by applying one or more of the plurality of selected rules until a condition is met, and in response to meeting the condition, outputting an answer to the query and the logical proof corresponding to the answer.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example encoder-decoder based transformer architecture for a large language model according to an embodiment of the present disclosure.

FIG. 5 illustrates an example flow chart for a method of controlling an AI device according to an embodiment of the present disclosure.

FIG. 6 illustrates an example flow chart for an overview of the framework according to an embodiment of the present disclosure.

FIG. 7 illustrates a pipeline architecture for the framework according to an embodiment of the present disclosure.

FIG. 8 illustrates a flow chart of an architecture for the framework according to an embodiment of the present disclosure.

FIG. 9 illustrates an example for operations of the method including a repair mechanism according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user. For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

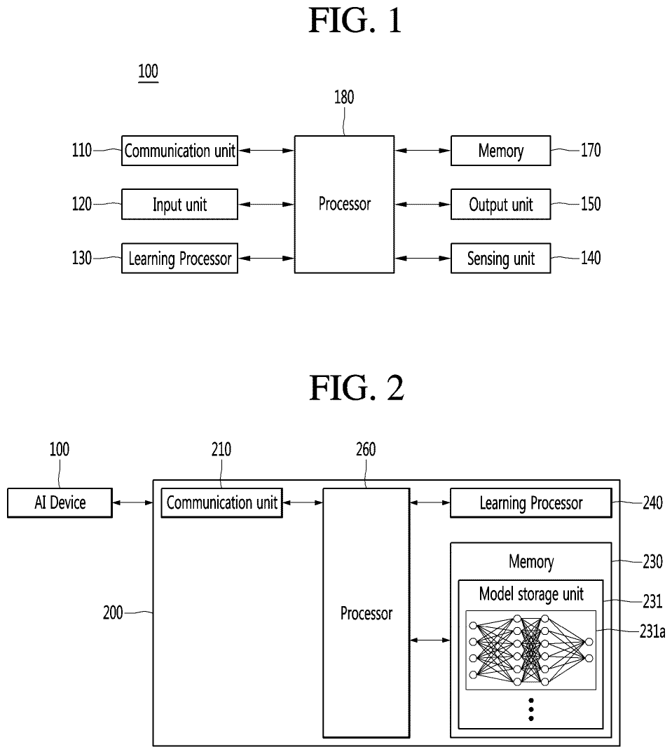

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

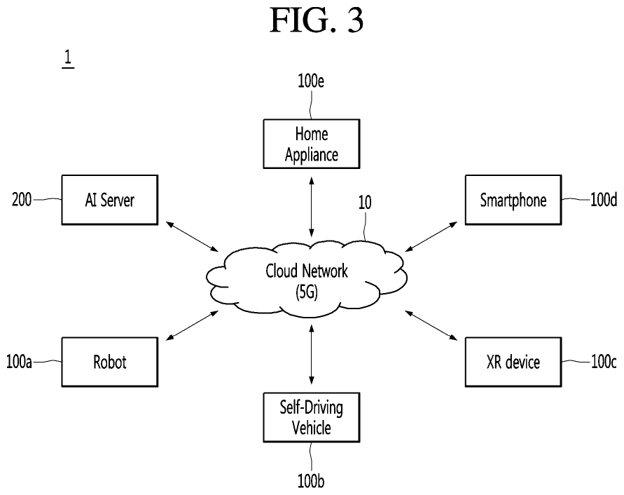

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement an AI model to generate output based on a plurality of modalities. Also, the generated output can be used by AI systems in various downstream related tasks other than text generate (e.g., object identification, control instructions to move a robot, control maneuvering for a self-driving vehicle, in game content generation, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input and produce an answer to a query, carry out an action or movement, animate a displayed avatar or a recommend an item or action.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data. According to embodiments, the AI model can be fully implemented on an edge device (e.g., locally on devices 100a to 100e) or fully implemented AI server 200 in which an edge device collected the raw audio and video signals to provide to the AI server 200. According to another embodiment, parts of the AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

In addition, the AI server 200 can learn the artificial neural network according to the machine learning algorithm instead of the AI devices 100a to 100e, and can directly store the learning model or transmit the AI model to the AI devices 100a to 100e.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart washing machine or dryer, smart refrigerator or other display device, which can implement one or more of a large language model (LLM), a chat-bot, a digital avatar assistant, an online shopping assistant or concierge, a question and answering system or a recommendation system, etc. The method can be in the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue, generate an output or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Also, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's emotional state and personal preferences.

According to an embodiment, the AI device 100 can provide a method for verifiable and repairable logical reasoning for a large language model (LLM) by receiving a natural language query, parsing the query into a formal logical structure, and utilizing a multi-component framework including a theory resolution engine and a repair module to generate a verifiable proof tree that can prioritize corrected information.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, embodiments of the present disclosure relate to the field of artificial intelligence (AI) and machine learning, and more particularly, to methods and systems for providing verifiable and repairable logical reasoning for large language models (LLMs) to enhance their reliability and trustworthiness in performing reasoning tasks.

For example, embodiments of the present disclosure can provide for an enhanced logical reasoning framework for artificial intelligence models or agents, which can be viewed as a foundational component for applications requiring high reliability outputs with transparent and auditable reasoning, such as automated legal analysis, smart home and appliance products, medical diagnostic assistants, financial compliance systems, and other domains where logical soundness is desirable.

As discussed above, the operational capabilities of artificial intelligence models and agents in the domain of logical reasoning face several challenges that limit their practical utility and reliability. While LLMs have demonstrated a remarkable ability to process and generate human-like text, their application in scenarios requiring rigorous, trustworthy reasoning is hampered by various limitations. The performance of these agents and models depends on their ability to generate a plausible answer as well as the logical soundness of the process used to derive that answer.

For example, an LLM may generate statements that may sound good but are factually incorrect or logically inconsistent (e.g., a hallucination). For instance, in a medical diagnostic context, an LLM might incorrectly associate a symptom with a rare disease, or in a legal context, it might misstate a legal precedent or cite to cases that do not exists.

Because these hallucinations are presented with the same confidence as correct information, they pose a significant risk and undermine the trustworthiness of the system in any application where factual accuracy and logical consistency are needed.

Another significant limitation is the lack of verifiability in the reasoning process of conventional LLMs. The neural network architecture of these models often functions as a type of black box, which can make it difficult or impossible to trace or audit the specific logical steps that led to a particular conclusion.

For example, a user can see the final output, but may not be able ask the system to show its work. This opacity stands in contrast to human reasoning or formal logical systems where a line of reasoning can be explicitly stated and examined for flaws. This inability to verify the reasoning path makes it difficult to trust the output for anything beyond creative or low-risk applications.

Also, this lack of verifiability leads to a further challenge, such as the inability to reliably debug or repair the model's reasoning. When an LLM produces an erroneous output, it can be difficult to pinpoint the specific point of failure within its internal process.

Accordingly, even if a user attempts to correct the model by providing new information, there is no guarantee that the model will consistently apply the correction in future, similar scenarios. These types of systems often do not provide a formal mechanism to ensure a repair is given precedence over the model's previously learned patterns.

A further challenge exists in prior attempts to combine LLMs with formal reasoning systems. For instance, systems that use an LLM merely to query a static knowledge base may lack the ability to extract and formalize the commonsense knowledge that is latent within the LLM itself.

Accordingly, a need exists for an improved system and method that can bridge these gaps by integrating the commonsense knowledge of an LLM into a framework that is verifiable, debuggable and guaranteed to be repairable even for future similar tasks.

For example, according to an embodiment, the AI device 100 can be configured with a multi-component framework that utilizes one or more artificial intelligence models, in which different components are configured to perform specialized tasks to overcome the aforementioned limitations. The framework can include, inter alia, an LLM-based parser to translate a natural language query into a formal logical structure, a theory resolution engine to systematically generate a proof tree, and a relevant rules selector to guide the engine by retrieving semantically relevant rules from a knowledge base. Further, a repair module can obtain or generate corrections and store them as high priority rules in the knowledge base, which can help ensure that the reasoning is repairable and that corrected logic is prioritized over prior flawed inferences to produce a fully verifiable and trustworthy output.

An LLM-based framework can offer many advantages. For example, Large Language Models (LLMs) can be used to implement or assist various components of the framework, such as the LLM-based parser and the relevant rules selector. These models can be configured to understand complex natural language queries and generate coherent, human-like responses, which enables the framework to interpret nuanced user queries and to perform semantic searches over the knowledge base to find the most relevant rules for a given step in the reasoning process, thereby enhancing the efficiency and effectiveness of the proof generation.

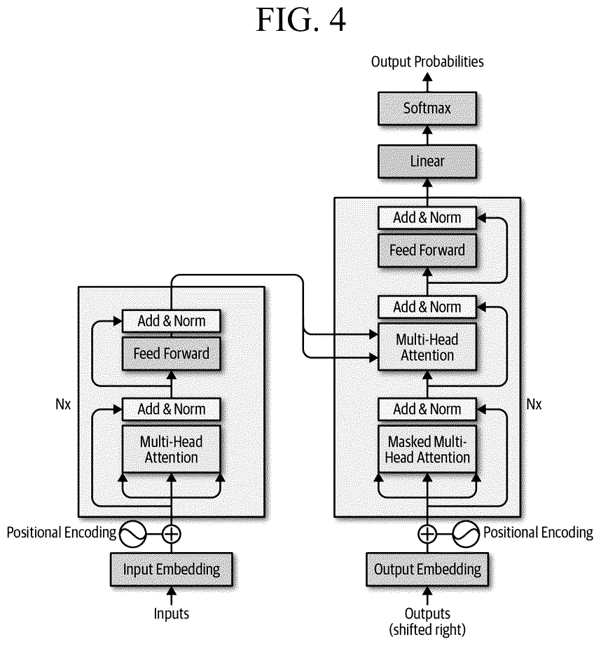

FIG. 4 illustrates an example encoder-decoder based transformer architecture for a large language model according to an embodiment of the present disclosure. For example, the method can leverage one or more large language models (LLMs). According to an embodiment, the LLM can be based on an encoder-decoder architecture, which employs self-attention mechanisms.

Further, these attention mechanisms can allow the model to weigh the importance of different parts of an input sequence (e.g., words in a sentence or sentences in a document) when processing information to allow the model to capture long-range dependencies and contextual relationships effectively, which is particularly relevant for understanding complex user queries or detailed product descriptions.

According to an embodiment, the LLM can undergo its own pre-training phase, in which the LLM is trained on a massive and diverse amount of text and code. During this unsupervised or self-supervised learning stage, the model can learn fundamental language patterns, grammatical structures, factual knowledge, and even reasoning capabilities (e.g., predicting masked words or the next sequence of text).

According to an embodiment, the LLM portion can be subject to a fine-tuning phase. Fine-tuning can involve further training the pre-trained model on smaller, more specialized datasets tailored to specific tasks (e.g., question answering, summarization, specific domain knowledge) or to align the model's behavior with desired characteristics, such as improved instruction following or safety protocols.

According to embodiments, the AI model can advantageously utilize pre-trained LLMs, potentially without requiring extensive task-specific fine-tuning for its core functionalities. For example, according to an embodiment, the AI model can be LLM agnostic, but embodiments are not limited thereto.

For example, the LLM portion can operate by processing textual inputs (e.g., prompts) which can include questions, instructions, or other text intended to elicit a specific response. The LLM can leverage its learned knowledge to generate a corresponding textual output, such as an answer, produce common sense reasoning, rules or axioms, a summary, or other contextually relevant content.

Also, according to an embodiment, the LLM portion can be multi-modal to accept and operate on other types of input, such as images, video, etc.

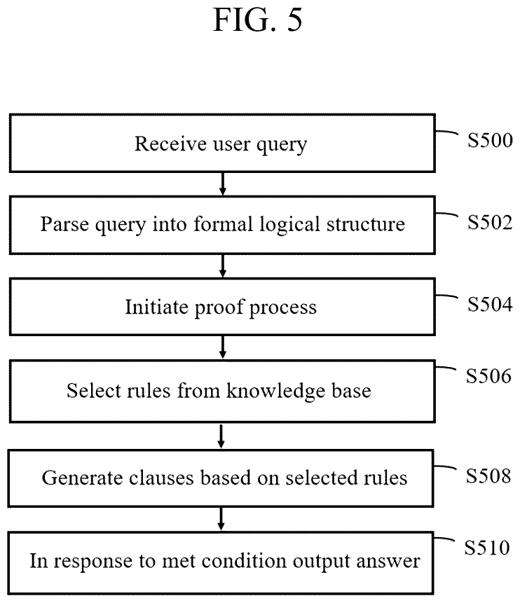

FIG. 5 shows an example flow chart of a method according to an embodiment of the present disclosure. For example, according to an embodiment, a method for controlling an AI device can include receiving, by a processor in the AI device 100, a query including natural language (e.g., S500), parsing, by a large language model-based parser, the query into a formal logical structure, such as NL-logic (e.g., S502), initiating, by a theory resolution engine, a proof process to generate a logical proof for the query (e.g., S504), selecting, by a rules selector, a plurality of selected rules from a knowledge base that are relevant to an active logical clause in the proof process (e.g., S506), generating, by the theory resolution engine, one or more logical clauses for the logical proof by applying one or more of the plurality of selected rules until a condition is met (e.g., deriving a logical contradiction) (e.g., S508), and in response to meeting the condition, outputting an answer to the query and the logical proof corresponding to the answer (e.g., S510).

Also, the method can further include the AI device 100 receiving or generating a repair axiom configured to correct an error in reasoning, storing the repair axiom in the knowledge base as a high priority rule, prioritizing, by the theory resolution engine during the proof process, the high priority rule over one or more other rules derived from a large language model, and generating the answer based on the repair axiom

According to an embodiment, the AI device 100 implementing the method can utilize a form of first-order logic (FOL). First-order logic is a formal system of logic that uses variables, quantifiers (e.g., ∀ “for all,” ∃ “there exists,” V “or,” ∧ “and,” etc.), and predicates to make statements about objects and their properties and relations. It can provide a mathematical foundation for representing knowledge and performing logical inference.

Further, the method can use natural language logic (e.g., NL-Logic). In NL-Logic, the standard abstract symbols used for predicates and constants in FOL can be replaced with natural language strings, which can be words or entire phrases. This can allow the LLM, which is trained on natural language, to directly interpret and reason about the logical statements. For example, the logical statement IsMan(Socrates) could be represented in NL-Logic as “is a man”(“Socrates”). This approach can create a bridge between the semantic understanding of the LLM and the structural rigor of the formal logic engine.

According to an embodiment, a mechanism of the theory resolution engine can be based on the resolution rule. For example, the resolution rule is a powerful rule of inference that allows for the generation of new logical statements, or clauses, from existing ones. A clause can be a disjunction of one or more literals, where a literal is an atomic statement (e.g., “is a man”(“Socrates”)) or its negation. The rule states that if two clauses contain complementary literals, that is, one clause contains a literal and the other clause contains its exact negation, then a new clause, referred to as the resolvent, can be derived which contains all the literals from the two original clauses except for the complementary pair that has been canceled out.

According to an embodiment, the theory resolution engine can employ the resolution rule within a proof by refutation framework. For example, to prove a query, the system can first assume that the negation of the query is true. It then can repeatedly apply the resolution rule to the set of all known clauses (including the negated query) to generate new resolvents.

Further in this example, a goal can be to derive an empty clause, which can represent a direct contradiction ⊥ (e.g., proving that a statement and its negation are both true). The derivation of a contradiction ⊥ demonstrates that the initial assumption (e.g., the negated query) must be false, thereby proving that the original query is true. This process can provide a systematic and logically sound process for verifying the query.

In more detail, the resolution rule can perform inference by deriving a resolvent clause from two premise clauses containing complementary literals. Given two FOL sentences in clausal form, a new clause can be derived via resolution of their complementary literals, e.g., see Equation 1 below, under the unification θ={x/y}.

$$\frac{A ( x ) ∨ B ( x ) ¬ B ( y ) ∨ C ( y )}{A ( x ) ∨ C ( x )} . \qquad [ Equation 1 ]$$

Following this procedure, new clauses can be derived by the AI device 100 until either a contradiction ⊥ is found (e.g., deriving both clauses A(x) and ¬A(x) that resolve to ⊥), or no further resolutions are possible. Finding a contradiction implies that the original set of clauses is inconsistent. Therefore, given the knowledge base K and a query q, to prove that K├q, one can apply the resolution inference rule to show that K∧¬q leads to a contradiction ⊥.

According to an embodiment, the method can enhance or extend the resolution rule by implementing theory resolution. Theory resolution can allow the reasoning engine to incorporate knowledge from an external “theory” source, such as commonsense statements by the LLM. For example, the framework can maintain a distinction between a stable, trusted “background theory” or “ground truth,” comprising the facts and high certainty rules in the knowledge base, and a temporary assumption (e.g., “temporary theory”) comprising the commonsense axioms generated by or known by the LLM for a specific query.

The theory resolution process can allow a clause from the background theory to be resolved with a clause from the LLM's temporary theory. This can enable the system to dynamically extract and integrate the LLM's vast commonsense knowledge directly into the formal proof process.

For example, a fact from the knowledge base, such as “is a bird”(“tweety”), could be resolved with a commonsense rule generated by the LLM, such as ¬“is a bird”(x)∨“can fly”(x) (e.g., if x is a bird, then x can fly). The resolvent would be the new clause “can fly”(“tweety”), which has been logically derived by combining a trusted fact with a commonsense axiom from the LLM. This mechanism can allow the system to perform more nuanced and powerful reasoning than would be possible with a static knowledge base alone.

In more detail, theory resolution is a methodology that can enable the integration of special purpose reasoning theories into resolution theorem proving, according to an embodiment. Based on theory resolution, given two clauses c₁=A(x)∨B(x) and c₂=C(x)∨D(x), if a theorem prover T identifies B(x) and ¬C(y) under unification θ={x/y} to be unsatisfiable (i.e., ∀xB(x)∧¬C(x)├_{T}⊥), despite lacking complementary literals with identical predicates, the two clauses can still be resolved, as shown below in Equation 2.

$$\frac{A ( x ) ∨ B ( x ) ¬ C ( y ) ∨ D ( y )}{A ( x ) ∨ D ( x )} . \qquad [ Equation 2 ]$$

For example, theory resolution can considerably broaden the applicability of the resolution inference rule by lifting the condition of resolving only complementary literals. According to an embodiment, an LLM as the theory that identifies the unsatisfiable natural language predicates can do reasoning via theory resolution.

According to an embodiment, the theory resolution process can address a significant limitation in related art semantic parsing approaches, which struggle to fully axiomatize the real-world meaning of information expressed in natural language.

For example, in a pure symbolic logic system, the concepts of a food being “spicy” and having “a kick to it” would be assigned completely different and unrelated predicates. A symbolic reasoner would be unable to identify the intuitive entailment relationship between them without a specific, pre-defined axiom.

However, according to an embodiment, the framework can include an LLM that is capable of understanding the semantic relationship between such phrases and can be used as the external theorem prover in the theory resolution framework. By employing the LLM in this role, the system can resolve two non-complementary literals if the LLM determines them to be logically related, thereby dynamically leveraging the LLM's commonsense knowledge to enable more powerful and nuanced reasoning within the NL-Logic system.

Further in this example, using the LLM theorem prover in the NL logic, the satisfiability condition of the theory resolution reduces to natural language entailment. In other words, if an LLM identifies a natural language predicate B to entail predicate D, i.e., B(x) ├_{LLM} D(x), and therefore, B(x)∧¬D(x) ├_{LLM} ⊥, then literals B(x) and ¬D(x) can be resolved. For instance, given clauses c₁=“kick to it”(x) and c₂=¬“spicy”(x)∨Q(x), in which Q(x) is another literal with a natural language predicate, since the LLM identifies the natural language entailment “kick to it” ├_{LLM} “spicy”, a theory resolution step can be performed as shown in Equation 3 below.

$$\frac{“ kick to it ” ( x ) ¬ “ spicy ” ( x ) ∨ Q ( x )}{Q ( x )} . \qquad [ Equation 3 ]$$

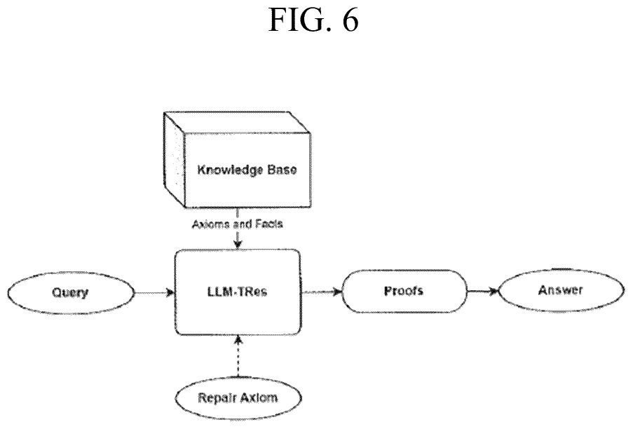

FIG. 6 shows a high-level block diagram of the logical reasoning framework, according to an embodiment. For example, the process can begin when a user submits a query to the central LLM-TRes component. The LLM-TRes component can be considered as type of core processing unit or controller responsible for managing the entire logical reasoning workflow, but embodiments are not limited thereto.

Further in this example, to perform its reasoning, the LLM-TRes component can receive a set of axioms and facts from a knowledge base. The knowledge base can serve as a repository of trusted information that can contain both permanent, human-verified rules and commonsense rules generated by the LLM.

Also, the LLM-TRes component can systematically process the query against the information from the knowledge base to generate one or more formal proofs. These proofs represent the verifiable, step-by-step logical argument that substantiates the final conclusion.

From the generated proofs, a final answer can be derived and presented to the user. The framework can also include a mechanism for repair, either by human intervention or a repair module such as another LLM-based component or hard-coded rules or heuristics, according to various embodiments.

For example, a repair axiom can be introduced to the system, which is fed into the LLM-TRes component. This can allow for the correction of faulty reasoning, and as will be described in more detail below, the system is configured to guarantee that such repairs are prioritized, which can ensure the reliability and trustworthiness of the final answer.

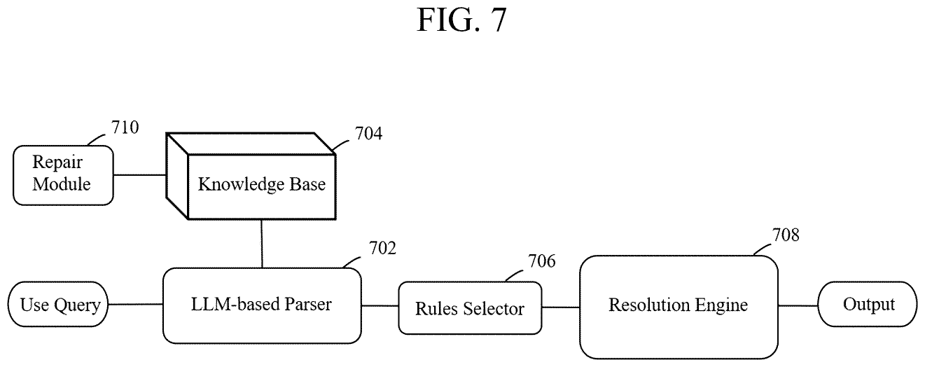

FIG. 7 illustrates an example flow chart for an overview of the framework according to an embodiment of the present disclosure. For example, according to an embodiment, the AI device 100 configured with the AI model can be implemented as a cohesive architecture of interconnected modules designed to implement the multi-phase workflow.

For example, the AI device 100 can include a plurality of interconnected components configured to receive a user query and output a verifiable answer. According to an embodiment, the components can include an LLM-based parser 702, a knowledge base 704, a rules selector 706, a resolution engine 708 (e.g., theory resolution engine or resolver), and a repair module 710.

The AI device 100 is configured to process a user query by first parsing it into a formal logical structure (e.g., NL-Logic), then using the resolution engine 708 to systematically build a proof by retrieving relevant rules from the knowledge base 704, as identified by the rules selector 706. The final output is a logically sound answer and can include its corresponding proof tree.

According to an embodiment, the LLM-based parser 702 can serve as the initial interface for receiving the user query in natural language. This component can utilize a large language model to translate the unstructured, human-readable query into a structured, formal logical representation, such as the NL-Logic format described herein. For example, this parsing step can convert the query into a format that can be processed by the downstream logical components of the system.

Similarly, the LLM-based parser 702 can also retrieve information from the knowledge base 704 in the form of natural language and convert it into a structured, formal logical representation (e.g., the NL-Logic format).

Further in this example, the knowledge base 704 can store a plurality of axioms and facts, which can include two primary types of rules, but embodiments are not limited thereto.

For example, type (i) rules can be human verified facts or known facts and logical rules with a probability of 1.0 (e.g., representing ground truths), and type (ii) rules can be commonsense axioms generated by an LLM (e.g., previously generated or on-demand), each having an associated probability score reflecting the LLM's confidence (described in more detail at a later section). The Knowledge Base 704 can also receive and store high priority repair axioms from the repair module 710.

In various embodiments, the knowledge base 704 can take several forms. For example, the knowledge base 704 can be implemented as a local database on the same AI device 100 as the other system components, such as a relational database, a graph database, a knowledge graph or a file based storage system in local memory.

Alternatively, the knowledge base 704 can be implemented as a remote repository, accessible over a network. For example, the knowledge base 704 can be implemented as a centralized database server, a distributed database system, or a cloud-based storage solution, which can allow multiple instances of the reasoning system to access a shared set of axioms and facts which can be updated or repaired by a large group or community of remote users or devices.

The rules selector 706 can operate as a type of efficiency enhancing component that guides the reasoning process. For example, according to an embodiment, to avoid the computationally expensive task of testing every rule in the knowledge base 704 at each step of a proof, the rules selector 706 can receive the current logical clause from the resolution engine 708 and perform a semantic search over the knowledge base 704 (e.g., cosine similarity, Euclidean distance, etc.).

For example, rules selector 706 can leverage an LLM's ability to understand language to identify and retrieve a small subset of the most semantically relevant rules to the current clause, which can then be provided to the resolution engine 708.

According to an embodiment, the resolution engine 708 is configured to perform logical processing and can be implemented as a non-LLM component using programming logic (e.g., Python code, etc.). The resolution engine 708 can orchestrate the proof generation process by managing a priority queue of logical clauses and systematically applying the theory resolution.

According to an embodiment, while the core resolution logic of the resolution engine 708 can be executed via code, the engine can call an LLM as a subroutine during the theory resolution process. This subroutine call can be used to determine the probability of an entailment between two logically related but non-complementary literals, and this probability can then be assigned to the new type (ii) rule that is extracted from the LLM (described in more detail at a later section).

Further in this example, resolution engine 708 can take the logical clauses and the relevant rules supplied by the rules selector 706 to iteratively build a proof tree. By finding a logical contradiction to the negated query, the resolution engine 708 can validate the query and generate the final output, which includes the answer and the complete, verifiable proof tree (an example algorithm for the resolution engine is described in more detail at a later section).

According to an embodiment, the repair module 710 can provide a mechanism for correction of the system's reasoning. For example, when a user identifies a flaw in the LLM's logic, the user can interact to create a repair axiom and input it to the repair module 710. For example, this repair axiom can be a new type (i) rule (e.g., a human verified rule).

Further, the repair module 710 can then store the repair axiom in the knowledge base 704. Due to the prioritization scheme of the resolution engine 708, this new high priority rule is guaranteed to be preferred over any conflicting, lower-probability rules from the LLM, thereby ensuring the system's reasoning is reliably repaired.

According to another embodiment, the function of the repair module 710 can be automated without direct user intervention. For example, the system can be configured to use a second LLM, acting as an automated judge, to review a completed proof tree for logical inconsistencies or low probability steps. For example, the second LLM acting as an automated judge can be a more powerful LLM having more parameters than a first LLM that generated the type (ii) rule. According to another embodiment, the two LLMs can be separate instances of a same LLM, e.g., using different prompts and function instructions.

Alternatively, a set of hard-coded heuristic rules can be used to detect common error patterns (e.g., pattern matching algorithms, etc.). Upon detecting a likely error, this automated process can generate and submit a repair axiom to the knowledge base 704 to allow the system to self-correct its reasoning autonomously.

According to another embodiment, the repair module 710 can automatically detect a potential error and notify the user to request input a repair axiom, but embodiments are not limited thereto.

According to an embodiment, one or more of the interconnected components can be located on an external device, such as a remote server, but embodiments are not limited thereto.

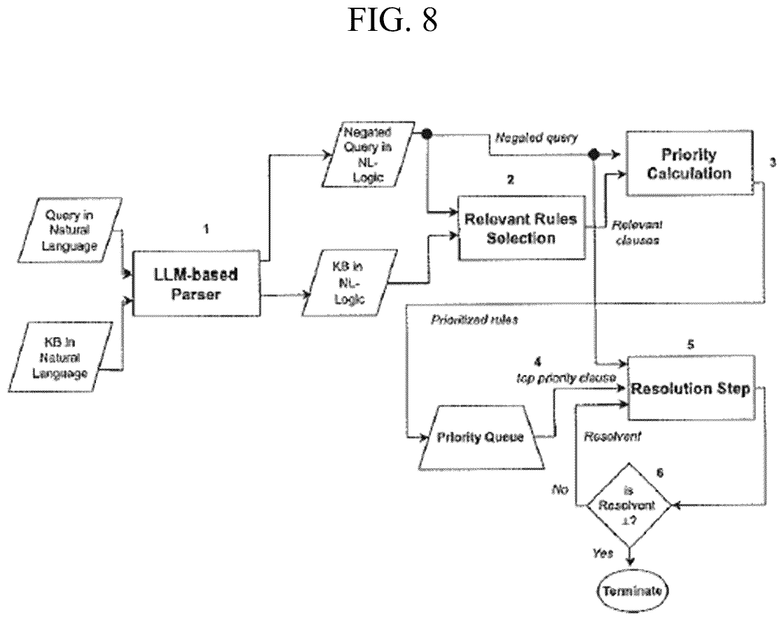

FIG. 8 is a flowchart illustrating method steps of the LLM-TRes framework, according to an embodiment. For example, the overall method can involve a cyclical process of parsing a query, selecting and prioritizing relevant rules, performing resolution to generate candidate clauses for resolution, and adding these clauses to a priority queue for subsequent iterations. This process can continue until a logical contradiction is found, at which point the system can backtrack through the chain of inferences to construct the final proof.

For example, as shown in step 1 of FIG. 8, the process can begin when the LLM-based parser receives a query in natural language (e.g., user query). The LLM-based parser can also receive information from a knowledge based (e.g., KB) in natural language. The parser utilizes an LLM to translate these unstructured text inputs into the structured NL-Logic format. This can produce knowledge base information in NL-Logic and, for the query, a negated query in NL-Logic which can serve as a starting point for the proof by refutation process.

Regarding step 2, the relevant rules selection component (e.g., rules selector) can receive the current active clause (e.g., initially, the negated query) and NL-Logic information from the knowledge base (e.g., KB).

According to an embodiment, the relevant rules selection component can use an LLM's semantic understanding to perform a targeted search of the knowledge base to make the search for a proof more efficient. For example, the relevant rules selection component can identify and select a small subset of relevant clauses that are most likely to resolve with the active clause, thus avoiding an exhaustive search of the entire knowledge base.

Further in this example, regarding step 3, the relevant clauses or rules selected in the previous step can be sent to the priority calculation component (e.g., priority calculator). This component can assess each candidate clause (e.g., each resolvent clause) and assign it a priority score.

According to embodiments, this score can be based on a combination of factors, including the probability of the rule (e.g., with human verified or ground truth type (i) rules having a higher priority than LLM-generated type (ii) rules) and the projected length of the proof path (e.g., proof plausibility score, proof length). The output can be a set of prioritized rules ready to be used in the resolution step.

As shown in step 4 of FIG. 8, after the resolution step 5 is performed, any new clauses that are generated (e.g., the resolvent) can be pushed into the priority queue. The priority queue can be a data structure that maintains a ranked list of all clauses that are pending investigation. This can ensure that in each subsequent iteration of the loop, the system will always work on the most promising clause first, as determined by the prioritization scheme.

Further in this example, regarding step 5, the core of the reasoning process can occur in the resolution step. At the beginning of each iteration, the system can take the top priority clause from the priority queue as the active clause. The resolution engine can then attempt to resolve this active clause with the prioritized rules or clauses from step 3. If a new resolvent clause is generated, the system can check if it is a contradiction (step 6). If not, the resolvent can be sent to the priority queue (step 4), and the loop can continue.

As shown in step 6 (e.g., contradiction and proof generation), the loop terminates when the resolution step produces a resolvent that signifies a logical contradiction (1). At this point, a valid proof has been found. The system can then backtrack through the sequence of ancestor clauses that led to the contradiction all the way back to the initial negated query. This chain of logical steps and their associated probability scores can be compiled into the final proof tree, which can then be output as part of the verifiable answer.

Table I below shows an example LLM-TRes algorithm for efficient logical commonsense reasoning based on theory resolution using LLMs, according to an embodiment.

TABLE I
Algorithm 1 LLM-TRes Algorithm

| | |
|---|---|
| 1: | Input: K, q, max_proofs, max_iters, b |
| 2: | proofs ← ∅ |
| 3: | PQ ← ∅ // PQ is an initially empty priority |
| | queue. |
| 4: | PQ.push(¬q, (1, 0)) // Negation of the initial |
| | query q has priority (1, 0), PQ is ordered by |
| | Equation 7 |
| 5: | while i < max_iters do |
| 6: | while PQ ≠ ∅ ∧ i < max_proofs do |
| 7: | c ← PQ.pop( ) |
| 8: | if c = ⊥ then |
| 9: | max_proofs++ |
| 10: | proofs ← proofs ∪ {c} |
| 11: | else |
| 12: | β_{c} ← b most likely candidates in K to |
| | resolve with c |
| 13: | for c_{target} ∈ β_{c} do |
| 14: | Compute resolvent cᵣₑₛ of c and |
| | c_{target} using Equation 2 |
| 15: | PQ.push(cᵣₑₛ, (ρ^{ε}(cᵣₑₛ), p^{l}(cᵣₑₛ)) // |
| | cf. Equations 5 and 6 |
| 16: | Output: proofs |

For example, according to an embodiment, an objective of the method can be formally defined. Given a set of queries (Q) and a knowledge base (KB), denoted as K, which comprises a set of axioms (A) and a set of facts (F), in which all information is represented in a natural language (NL)-Logic clausal form, the system is configured to apply an inference process.

For each query (q) within the set of queries (Q), the inference process is configured to find a set of proofs, in which each individual proof within the set includes a subset of clauses from the knowledge base (K) and is assigned a priority score rho (φ that reflects the priority of the said proof.

In addition, to prove that the knowledge base (K) entails a given query (q), the system can be configured to demonstrate that iteratively applying the resolution to derive new clauses from K∧¬q leads to a logical contradiction, thereby proving its unsatisfiability.

According to embodiments, an option in this process concerns the selection of a clause to begin the resolution proof. According to embodiments, two options exist for this part of the process, such as forward chaining and backward chaining. Forward chaining begins from the clauses in the knowledge base (K) to derive the query (q) itself, while backward chaining begins from the negation of the query (¬q) and resolves it with clauses from the knowledge base (K) to reach a contradiction.

According to an embodiment, the system can employ backward chaining, as this goal driven approach can significantly improve efficiency when reasoning over natural language by ensuring all reasoning steps remain relevant to the initial query, but embodiments are not limited thereto. Therefore, the negated query (¬q) can be designated as the first active clause for the resolution process.

Further, a significant challenge arises from the potentially enormous size of the knowledge base (K). This challenge is compounded during the resolution process, as the iterative generation of new resolvent clauses can lead to a combinatorial expansion of the search space that should be explored to find a proof.

According to an embodiment, to maintain computational efficiency in this large and dynamic search space, the system can be configured to employ at least two strategic approaches. For example, a first strategy can involve prioritizing the resolvent clauses that are generated, such that the system selectively determines which logical paths to pursue based on a calculated priority score, and a second strategy can involve actively restricting the search space for the theory resolution process by leveraging semantic similarity to identify only the most relevant candidate clauses for resolution at each step of the proof.

According to an embodiment, a mechanism for enabling efficient resolution is a prioritization scheme for candidate clauses. This scheme is configured to give precedence to resolvent clauses that have a higher potential of belonging to a plausible proof over clauses generated from less plausible resolution steps.

Further, the plausibility of a given theory resolution step, in which an active clause c is resolved with a target clause c_{target} to produce a resolvent clause cᵣₑₛ, can be quantified by a plausibility score, denoted as ρ (rho), according to Equation 4 below. This score is determined by calculating the probability, as assigned by an LLM, that the target clause c_{target} logically entails the active clause c.

$${ρ}_{{c}_{res}}^{entail} = p ( {c}_{target} {⊢}_{LLM} c ) . \qquad [ Equation 4 ]$$

According to an embodiment, the calculated plausibility scores can be utilized to prioritize the resolvent clauses for subsequent processing. For example, a first resolvent derived from a resolution step having a higher entailment score can be prioritized over a second resolvent derived from a step with a lower entailment score, as the first resolvent is more likely to be part of a final, plausible proof.

To identify the most plausible proofs, which can be defined as the sequences of theory resolution steps having the highest accumulated entailment scores, a priority score can be defined for each resolvent clause (cᵣₑₛ). The priority score can be determined by the overall entailment score of all resolution steps, beginning from the original negated query, which led to the derivation of cᵣₑₛ. Denoting the set of parent clauses of cᵣₑₛ as P_{cres}, the overall proof entailment score for cᵣₑₛ can be inductively defined according to Equation 5, below.

$${ρ}^{e} ( {c}_{res} ) = ( {\prod }_{{c}^{′} ∈ {𝒫}_{{c}_{res}}} {ρ}^{e} ( {c}^{′} ) ) \cdot {ρ}_{{c}_{res}}^{entail} . \qquad [ Equation 5 ]$$

According to an embodiment, when choosing between two or more proofs of equal plausibility, the system can be configured to prefer shorter proofs that avoid redundant reasoning steps. To implement this preference, a second priority score can be assigned to each resolvent clause to reflect the length of the proof path.

For example, this second score can be configured to be considered only as a tie breaker when the primary proof entailment scores for two proofs or clauses are equal. Similar to the proof entailment score, the proof length score for a given resolvent clause (cᵣₑₛ) can be obtained inductively from the maximum proof length of its parent clauses, according to Equation 6 below.

$${ρ}^{l} ( {c}_{res} ) = 1 + {max}_{{c}^{′} ∈ {𝒫}_{{c}_{res}}} {ρ}^{l} ( {c}^{′} ) . \qquad [ Equation 6 ]$$

Further in this example, the final priority score for each resolvent clause cᵣₑₛ can be formed as the tuple (ρ^{e}(cᵣₑₛ), ρ^{l}(cᵣₑₛ)) and all resolvents can be pushed to a priority queue PQ. The total order of clauses in priority queue PQ is then determined as Equation 7 below.

$${c}_{1} ⪯ {c}_{2} ⟺ [ {ρ}^{e} ( {c}_{1} ) > {ρ}^{e} ( {c}_{2} ) ] ∨ [ ( {ρ}^{e} ( {c}_{1} ) = {ρ}^{e} ( {c}_{2} ) ) ∧ ( {ρ}^{l} ( {c}_{1} ) < {ρ}^{l} ( {c}_{2} ) ) ] . \qquad [ Equation 7 ]$$

According to an embodiment, the AI device 100 can be configured to restrict the theory resolution search space to enhance computational efficiency. A knowledge base may contain a large number of axioms and facts, many of which may be irrelevant to the active clause at a given step in the proof process. To maintain a tractable search space, the system can restrict the resolution process by a branching factor, b, by selecting only a subset of candidate target clauses based on their semantic relevance to the current active clause.

For example, this can be achieved by generating a word embedding vector for the active clause, c, denoted as ze, and word embedding vectors for each candidate clause, c′, denoted as ze′. The system can then calculate similarity scores (e.g., cosine distance) between these vectors to identify B_{c}, which is the set of b most semantically relevant clauses to c, as defined by Equation 8.

$${β}_{c} = \{ {c}^{′} \vert ( {c}^{′} ∈ 𝒦 ) ∧ ( {c}^{′} \neq c ) ∧ ( {z}_{c}^{′} {z}_{{c}^{′}} ⩾ τ ) \} , \qquad [ Equation 8 ]$$

In Equation 8 above, a threshold τ can be set to the b^{th} highest inner product score between the embedding of the active clause c and the embeddings of the other clauses, thereby resulting in the selection of the top-b theory resolution candidates. Subsequently, theory resolution can be performed between the active clause c and each candidate clause within the selected set B_{c}, in accordance with Equation 2.

For example, the combination of these two mechanisms, e.g., the prioritization of clauses and the semantic restriction of the search space, can enable an efficient inference process via LLM-based theory resolution. At the beginning of each iteration of the method, the clause holding the foremost position in the priority queue can be designated as the active clause. Once a resolution step leads to a contradiction, the corresponding proof and its respective priority score can be added to a set of found proofs by backtracking through the ancestor clauses up to the original negated query.

Further in this example, the algorithm can be configured to continue its iterative process until a predetermined number of proofs are found or a maximum number of iterations is exceeded. The system is not limited to finding a single proof for a query, but is instead configured to generate a set of proofs, in which each proof in the set is assigned a corresponding strength score.

This functionality can enable the system to assess the likelihood that each query is entailed, which is particularly beneficial for applications that require the ranking of multiple potential answers, such as in a multiple-choice question scenario. Furthermore, in applications where a binary truth value for the query is desired, the system can be configured to compare the proof scores of the query (q) and its negation (¬q) to determine the final truth value.

According to an embodiment, the system can be configured to provide access to each atomic inference step within the resolution process, thereby enhancing the verifiability and debuggability of the reasoning framework. While the entailment probabilities assigned by the LLM may be erroneous, the framework is configured such that the specific resolution step at which a failure occurs is discernible by a user or by an automated repair module, according to embodiments.

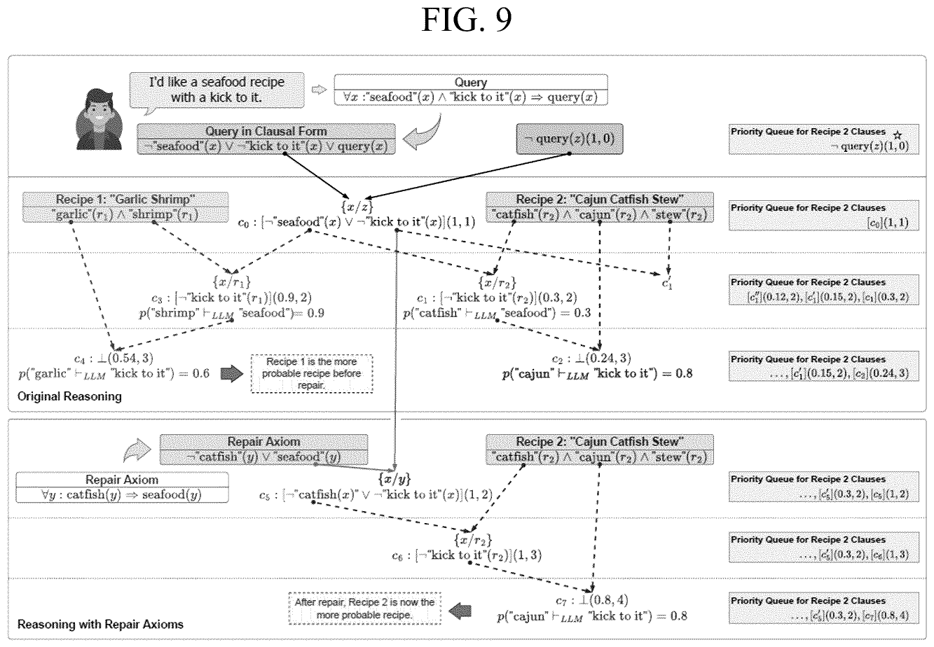

Furthermore, such an error can be corrected by introducing a rectifying rule, or repair axiom, into the knowledge base. For example, as illustrated in FIG. 9, an LLM's error in assigning a low entailment score to the logical relationship between “catfish” and “seafood” can lead to an incorrect reasoning path. However, the introduction of the correct axiom, ∀y “catfish”(y)=⇒“seafood”(y), into the knowledge base as a high-priority rule effectively repairs this mistake for all subsequent reasoning.

In other words, with reference to Table 1 again, Algorithm 1 describes the workflow of the reasoning engine, which performs a systematic search for a logical proof, according to an embodiment.

The primary objective of the algorithm is to prove that an initial query, q, is logically entailed by a knowledge base, K, by demonstrating that the combination of K and the negation of the query, ¬q, leads to a logical contradiction, denoted as ⊥. This is accomplished by repeatedly applying resolution to combine clauses and derive new ones until a contradiction is found or a termination condition is met.

The operation of the algorithm can be described in a series of steps. First, the algorithm is initialized with its inputs, which can include the knowledge base K, the query q, termination conditions such as max_proofs or max_iters, and a branching factor b that defines the number of candidate clauses to consider. An empty set, proofs, is created to store any completed proofs, and a priority queue, PQ, is initialized to manage the clauses to be processed. The process begins by adding the negation of the query, ¬q, to the PQ with a high priority.

The algorithm then enters its main iterative loop, which continues as long as the PQ is not empty and the termination conditions have not been met. In each iteration, the highest-priority clause, c, is removed from the PQ for processing.

Further in this example, if this clause c is a contradiction (e.g., symbol ⊥), a proof has been successfully found, and it is added to the proofs set. If c is not a contradiction, the search continues. The b most semantically relevant clauses, βc, are selected from the knowledge base K to resolve with c.

Also, the theory resolution is then applied between c and each of these target clauses, c_{target}, to generate a new resolvent clause, cᵣₑₛ. This new clause, cᵣₑₛ, is then added to the priority queue PQ with a newly calculated priority score. Once the loop terminates, the algorithm outputs the set of proofs that have been found, thereby providing one or more verifiable lines of reasoning for the original query q.

FIG. 9 illustrates an example for operations of the method including a repair mechanism according to an embodiment of the present disclosure.

For example, according to an embodiment, FIG. 9 shows a detailed, step by step illustration of the method's operation, including an initial reasoning process, the identification of a flaw in the reasoning, and the subsequent correction of the flaw through the use of a repair axiom.

The process can begin when the system receives a user query, such as “I'd like a seafood recipe with a kick to it.” The AI device 100 can first translate this query into a formal NL-Logic statement, ∀x: “seafood”(x)∧“kick to it”(x)=⇒query(x), and initiates the proof process by adding the negation of the query, ¬query(z), to a priority queue.

In an initial reasoning phase, the AI device 100 can evaluate a plurality of potential candidates, such as a first recipe, “Garlic Shrimp,” and a second recipe, “Cajun Catfish Stew.”

For the first recipe, the AI device 100 can use a first commonsense rule from an LLM indicating with a high probability (e.g., 0.9) that “shrimp” entails “seafood,” and a second rule indicating with a moderate probability (e.g., 0.6) that “garlic” provides a “kick.”

Further in this example, for the second recipe, AI device 100 may know it contains “cajun” and “catfish.” The LLM may provide a high-confidence rule (e.g., 0.8) that “cajun” provides a “kick,” but may also generate a low-confidence rule, or hallucination, indicating with a very low probability (e.g., 0.3) that “catfish” entails “seafood.” Based on these probabilities, the system would initially conclude that the first recipe, “Garlic Shrimp,” is the more probable and correct answer due to the weakness of the logical link for the second recipe.

AI device 100 can be further configured to allow for the correction of such a flawed reasoning path. A user or an automated module may identify the LLM's error in assigning a low entailment score to the “catfish” and “seafood” relationship and can introduce a repair axiom.

This axiom, for example, ∀y: catfish(y)⇒seafood(y), can be a human verified, type (i) rule with a probability of 1.0. When the AI device 100 re-evaluates the proof for “Cajun Catfish Stew,” it is configured to prioritize this new high-certainty rule over the LLM's original low-confidence guess.

The logical connection establishing that the stew is a “seafood” dish becomes definitive (e.g., probability 1.0), while the high-confidence rule for the “kick” remains. As a result, the combined logical path for “Cajun Catfish Stew” becomes significantly stronger, leading the AI device 100 to correctly conclude that it is the more probable and better recipe, thereby demonstrating that the repair mechanism is both effective and guaranteed to be prioritized.

Table II below shows another example of the reasoning method, according to an embodiment.

TABLE II
Query: The crowd intensified.
Optioins: 1- The father handed his son some money., 2- The father grabbed his son’s hand.
Answer: The father grabbed his son’s hand.
Rules: 1- (an intense crowd, capable of, making your son hard to find), 2- (making your son hard to
find, causes desire, keep an eye on son), 3- (keeping an eye on son, results in, grabbing son’s hand), 4-
(handing money to son, causes, son having money), 5- (father, capable of, handing money to son)
Ground Truth Proof: 1, 2, 3.
LLM-TRes:
Proof for Option 1:
Negation of query: [symbol] handing his son money(father)
Step 1-
$\frac{\text{?} handing his son money ( father ) \text{?} making son hard to find ( x ) ∨ keep an eye on son ( x )}{making son hard to find ( man )} θ = [ x / father ] .$
Step 2-
$\frac{\text{?} making son hard to find ( x ) \text{?} intense crowd ( x ) ∨ could make finding son hard ( x )}{\text{?} intense crowd ( x )} θ = [ x / father ] .$
Step 3-
$\frac{\text{?} instense crowd ( x ) \text{?} intensified crowd ( x )}{\text{?}} .$
Proof score: ρ [symbol] = (0.005, 3)
***
Proof for Option 2:
Negation of query: [symbol] grabbed son’s hand(father)
Step 1-
$\frac{\text{?} grabbed son ’ s hand ( father ) \text{?} making son hard to find ( x ) ∨ keeping an eye on son ( x )}{\text{?} making son hard to find ( man )} θ = [ x / father ] .$
Step 2-
$\frac{\text{?} making son hard to find ( x ) \text{?} intense crowd ( x ) ∨ could make finding son hard ( x )}{\text{?} intense crowd ( x )} θ = [ x / father ] .$
Step 3-
$\frac{\text{?} instense crowd ( x ) \text{?} intensified crowd ( x )}{\text{?}} .$
Proof score: ρ [symbol] = (0.883, 3)
***
Since ρ [symbol] > ρ [symbol] , the answer is Option2. [symbol]
indicates data missing or illegible when filed

Table II shows an example application of the reasoning framework to a causal common sense reasoning task, demonstrating the method's ability to evaluate multiple competing hypotheses and select the most logically plausible conclusion.

In this example, the AI device 100 is provided with a context, or query, stating, “The crowd intensified,” and two possible resulting actions, e.g., option 1—“The father handed his son some money,” and option 2—“The father grabbed his son's hand.” The objective is to determine which of the two options is the more likely consequence of the initial query by generating a formal proof for each and comparing their logical strength.

As shown in Table II, the AI device 100 configured with the LLLM-Tres framework attempts to prove both options by initiating a separate proof b refutation process for each. For option 1, the process begins with the negated clause, e.g., ¬handing his son money (father). The AI device 100 then iteratively applies the theory resolution using a set of provided commonsense rules to derive new clauses in a step by step manner until a logical contradiction (⊥) is reached. A proof score, ρₒₚₜᵢₒₙ₁, is then calculated for this completed proof, which in this example is a relatively low score of (0.005, 3), indicating a weak logical entailment.

Further in this example, the AI device 100 performs the same process for option 2, starting with the negated clause ¬grabbed son's hand (father). It again applies a series of resolution steps using the available rules and successfully derives a contradiction.

For this second proof, the AI device 100 calculates a proof score, ρₒₚₜᵢₒₙ₂, of (0.883, 3), which is significantly higher than the score for the first option. By comparing the two proof scores, the AI device 100 concludes that ρₒₚₜᵢₒₙ₂>ρₒₚₜᵢₒₙ₁, and therefore determines that option 2 is the more plausible and logically sound answer.

This example demonstrates advantages of the method, in which it can find valid proofs as well as quantitatively assess and rank the plausibility of competing conclusions based on the strength of their respective logical foundations.

Various experiments were carried out against related art models to evaluate the results for the method according to embodiment. For example, according to an embodiment, the performance of the disclosed framework (e.g., LLM-Tres) was evaluated against a plurality of related art reasoning methods across several diverse benchmark datasets to demonstrate its efficacy

As shown in Table III below, the model according to embodiments outperforms other related-art methods.

TABLE III

| | RecipeMPR | | | ProntoQA | | | COPA-SSE | | |
|---|---|---|---|---|---|---|---|---|---|
| Method | Accuracy | RS Macro | RS Micro | Accuracy | RS Macro | RS Micro | Accuracy | RS Macro | RS Micro |
| CoT (GPT-3.5-Turbo) | [symbol] | [symbol] | [symbol] | [symbol] | [symbol] | [symbol] | [symbol] | [symbol] | [symbol] |
| CoT (Llama3 8B) | [symbol] | [symbol] | [symbol] | [symbol] | [symbol] | [symbol] | [symbol] | [symbol] | [symbol] |
| CoT ( [symbol] 7B) | [symbol] | Fail | Fail | [symbol] | [symbol] | [symbol] | [symbol] | [symbol] | [symbol] |
| CoT ( [symbol] 7B) | [symbol] | [symbol] | [symbol] | [symbol] | [symbol] | [symbol] | [symbol] | [symbol] | [symbol] |
| LAMBADA (GPT-3.5-Turbo) | NA | NA | NA | [symbol] | [symbol] | [symbol] | NA | NA | NA |
| Pure Entailment (BART 406M) | [symbol] | NA | NA | [symbol] | NA | NA | [symbol] | NA | NA |
| LLM-TRes (BART 406M) | [symbol] | [symbol] | [symbol] | [symbol] | [symbol] | [symbol] | [symbol] | [symbol] | [symbol] |

[symbol]

indicates data missing or illegible when filed

For example, the evaluation was conducted on three distinct reasoning tasks: Recipe-MPR (e.g., preference reasoning), ProntoQA (e.g., deductive reasoning), and COPA-SSE (e.g., causal commonsense reasoning). The performance of LLM-TRes was compared against related art methods including Chain-of-Thought (CoT) prompting with various large language models (e.g., GPT-3.5-Turbo, Llama3 8B), as well as other established methods such as LAMBADA and Pure Entailment.

The evaluation measured performance using at least two types of metrics, such as final answer “Accuracy” and “Reasoning Score” (RS), with RS Macro and RS Micro representing different methods of calculating the soundness of the logical proof. With respect to accuracy, the results indicate that the LLM-TRes framework achieves a high degree of accuracy that is comparable or superior to the other methods, even though the LLM-TRes framework used a much smaller model with fewer parameters (e.g., 406 million vs. 7 billion+ parameters). For example, on the ProntoQA dataset, LLM-TRes achieved an accuracy of 0.990, significantly outperforming all other tested configurations.

Another advantage of the LLM-TRes framework is demonstrated by the Reasoning Score (RS) metrics. For example, the LLM-TRes framework consistently achieved perfect or near-perfect RS Macro and RS Micro scores of 1.000 on both the Recipe-MPR and ProntoQA datasets. This demonstrates that the method can produce a correct final answer and does so using a verifiable proof that is logically sound.

According to an embodiment, the AI device 100 can be configured to achieve improved commonsense logical reasoning. The AI device 100 can be used in various types of different situations.

According to one or more embodiments of the present disclosure, the AI device 100 can solve one or more technological problems in the existing technology, such as the providing the ability to perform LLM-based logical reasoning in a manner that is verifiable, debuggable, and repairable, by implementing a multi-component framework that integrates the commonsense knowledge of an LLM with a formal theory resolution engine to generate transparent proof trees, mitigate hallucinations, and guarantee that corrections are prioritized, thereby enhancing the overall reliability and trustworthiness.

For example, embodiments of the present disclosure can address the deficiencies of related art logical reasoning systems, which suffer from uncontrolled content hallucination, an opaque “black box” type of process that prevents verifiability of the reasoning steps, and the lack of a formal mechanism to debug or reliably repair flawed logic in a manner that guarantees the correction will be prioritized.

Also, according to an embodiment, the AI device 100 configured with the pipeline method can be used in a mobile terminal, a smart TV, a home appliance, a robot, an infotainment system in a vehicle, etc.

For example, the AI device 100 and method can be applied in a wide range of interactive applications, including conversational agents, question-and-answering systems, and intelligent digital assistants. According to an embodiment, a digital assistant can leverage the disclosed framework to provide answers that are accurate as well as logically sound and verifiable. For example, when a user asks a complex question, such as troubleshooting a malfunctioning device, the system can provide a step by step diagnostic process as a formal proof, allowing the user to understand the reasoning behind each suggestion and increasing trust in the provided solution.

Further, the disclosed method can provide significant advantages for professional domains where auditable and reliable reasoning is a critical requirement. In the legal field, the framework can be used to create legal analysis tools that can examine case law and statutes to construct a formal legal argument. For example, a human attorney can then review the generated proof tree to verify the soundness of each logical step, ensuring that the argument is sound.

Similarly, in medical applications, the method can be used as a diagnostic assistant that provides a verifiable line of reasoning for a potential diagnosis based on symptoms and patient data to allow a medical professional to audit the logical connections and ensure patient safety.

In an enterprise context, the method can be used to develop and train specialized assistants for financial compliance, automated auditing, or complex customer service scenarios.

For example, a compliance bot or co-pilot application can use the framework to analyze a set of transactions and produce a verifiable proof demonstrating whether they adhere to a set of regulatory rules. This can provide a transparent and auditable record for internal controls and external reporting.

In customer service, the method can be applied to handle complex policy questions by providing answers that are verifiably consistent with the company's official guidelines, reducing the risk of providing incorrect information to customers.

In addition, the methods and systems disclosed herein have applicability in the field of smart home appliances and consumer electronics. For example, a smart home hub can use the framework to make more reliable and personalized recommendations or actions. When suggesting a recipe, the system can generate a proof showing how the suggestion meets a user's dietary restrictions, available ingredients and user preferences. The repairability of the system is also advantageous in this context because a user can easily correct the system's understanding (e.g., “I am allergic to nuts”), and this correction is guaranteed to be prioritized in all future recommendations, leading to a safer and more personalized user experience.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, Python, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
receiving, by a processor in the AI device, a query including natural language;
parsing, by a large language model-based parser, the query into a formal logical structure;
initiating, by a theory resolution engine, a proof process to generate a logical proof for the query;
selecting, by a rules selector, a plurality of selected rules from a knowledge base that are relevant to an active logical clause in the proof process;
generating, by the theory resolution engine, one or more logical clauses for the logical proof by applying one or more of the plurality of selected rules until a condition is met; and
in response to meeting the condition, outputting an answer to the query and the logical proof corresponding to the answer.

2. The method of claim 1, wherein the generating the one or more logical clauses for the logical proof by applying the one or more of the plurality of selected rules until the condition is met includes:
generating, by the theory resolution engine, the one or more logical clauses for the logical proof by iteratively applying the plurality of selected rules until a logical contradiction is derived; and
in response to deriving the logical contradiction, outputting the answer and the logical proof.

3. The method of claim 1, further comprising:
receiving, by a repair module, a repair axiom configured to correct an error in reasoning;
storing the repair axiom in the knowledge base as a high priority rule;
prioritizing, by the theory resolution engine during the proof process, the high priority rule over one or more other rules derived from a large language model; and
generating the answer based on the repair axiom.

4. The method of claim 1, wherein the selecting the plurality of selected rules is based on a semantic relevance between the active logical clause and one or more rules in the knowledge base, and
wherein the semantic relevance is determined based on a vector embedding of the active logical clause and one or more vector embeddings corresponding to the one or more rules.

5. The method of claim 1, further comprising:
parsing the query into a negated query and designating the negated query as the active logical clause during the proof process for performing a backward chaining proof process.

6. The method of claim 1, wherein the generating the one or more logical clauses is managed by a priority queue, and
wherein the method further comprises:
calculating, for each of the one or more logical clauses, a priority score; and
adding each of the one or more logical clauses to the priority queue based on the priority score.

7. The method of claim 6, wherein the priority score is a tuple including at least a first value representing a proof entailment score and a second value representing a proof length score.

8. The method of claim 1, wherein the formal logical structure is a Natural Language (NL)-Logic structure representing one or more predicates by natural language strings.

9. The method of claim 8, wherein the NL-Logic structure utilizes a function-free and equality-free first-order logical syntax.

10. The method of claim 1, wherein the knowledge base includes:
a first set of type one rules having a first probability corresponding to ground truth rules known to be correct, and
a second set of type two rules having a second probability of being correct that is lower than the first probability, the second set of rules being derived from a large language model.

11. The method of claim 1, wherein the logical proof is a proof tree including a plurality of base premises, one or more rules of inference, one or more intermediate subgoals derived from applying the one or more rules of inference to the plurality of base premises, and a final goal corresponding to the query.

12. The method of claim 1, wherein the generating the one or more logical clauses includes:
calling, by the theory resolution engine, a large language model as a subroutine to determine a probability of an entailment for at least one axiom or rule extracted during the proof process; and
generating a logical clause based on the probability of the entailment.

13. The method of claim 1, wherein the logical proof is assigned a priority score based on an accumulated probability of a plurality of rules used to generate the logical proof.

14. An artificial intelligence (AI) device, comprising:
a memory configured to store information for a large language model; and
a controller configured to:
receive a query including natural language,
parse, by a large language model-based parser, the query into a formal logical structure,
initiate, by a theory resolution engine, a proof process to generate a logical proof for the query,
select, by a rules selector, a plurality of selected rules from a knowledge base that are relevant to an active logical clause in the proof process,
generate, by the theory resolution engine, one or more logical clauses for the logical proof by applying one or more of the plurality of selected rules until a condition is met, and
in response to meeting the condition, outputting an answer to the query and the logical proof corresponding to the answer.

15. The AI device of claim 14, wherein the controller is further configured to:
generate, by the theory resolution engine, the one or more logical clauses for the logical proof by iteratively applying the plurality of selected rules until a logical contradiction is derived, and
in response to deriving the logical contradiction, output the answer and the logical proof.

16. The AI device of claim 14, wherein the controller is further configured to:
obtain a repair axiom configured to correct an error in reasoning,
store the repair axiom in the knowledge base as a high priority rule,
prioritize, by the theory resolution engine during the proof process, the high priority rule over one or more other rules derived from a large language model, and
generate the answer based on the repair axiom.

17. The AI device of claim 14, wherein the controller is further configured to:
select the plurality of selected rules based on a semantic relevance between the active logical clause and one or more rules in the knowledge base, and
wherein the semantic relevance is determined based on a vector embedding of the active logical clause and one or more vector embeddings corresponding to the one or more rules.

18. The AI device of claim 14, wherein the controller is further configured to:
parse the query into a negated query and designate the negated query as the active logical clause during the proof process for performing a backward chaining proof process.

19. The AI device of claim 14, wherein the controller is further configured to:
calculate, for each of the one or more logical clauses, a priority score, and
add each of the one or more logical clauses to a priority queue based on the priority score.

20. A non-transitory computer readable medium storing computer-executable instructions that when executed by a processor, cause the processor to perform the operations of:
Receiving a query including natural language;
parsing, by a large language model-based parser, the query into a formal logical structure;
initiating, by a theory resolution engine, a proof process to generate a logical proof for the query;
selecting, by a rules selector, a plurality of selected rules from a knowledge base that are relevant to an active logical clause in the proof process;
generating, by the theory resolution engine, one or more logical clauses for the logical proof by applying one or more of the plurality of selected rules until a condition is met; and
in response to meeting the condition, outputting an answer to the query and the logical proof corresponding to the answer.
